(19) United States
(12) Patent Application Publication
(10) Pub. No.: US 2006/0068115 A1
(43) Pub. Date: Mar. 30, 2006

(54) Coating method, optical film and antireflective film

(75) Inventor: Tomonari Ogawa, Fujinomiya-Shi (JP)

Correspondence Address: YOUNG & THOMPSON, 745 SOUTH 23RD STREET, 2ND FLOOR, ARLINGTON, VA, 22202, US

(73) Assignee: FUJI PHOTO FILM, CO., LTD., MINAMI-ASHIGARA-SHI (JP)

(21) Appl. No.: 11/236,613

(22) Filed: Sep. 28, 2005

(30) Foreign Application Priority Data
Sep. 30, 2004 (JP) 2004-287792

(51) Int. Cl. B05D 3/12

(52) U.S. Cl. 427/356

(57) ABSTRACT

A coating method includes the steps of: providing a pressure reducing chamber and a slot die adjacent to each other from an upstream side in a moving direction of a base material, providing a backup roller so as to face the slot die, and coating a coating liquid on the base material using the slot die, the base material being subjected to tension by the pressure reducing chamber, wound around the backup roller and continuously moved, wherein when A=η×V×h×L×1/D³, the coating liquid is coated under 2 N/m²≦A≦700 N/m², where η is coating liquid viscosity, V is a coating speed, h is a coating film thickness in a wet state, L is a slot length, and D is a slot width.

### BACKGROUND OF THE INVENTION

1. Field of the Invention

The present invention relates to a coating method, an optical film and an antireflective film. More particularly, the present invention relates to a coating method suitable for forming a uniform thin coating film, and an optical film, in particular, an antireflective film manufactured using the coating method.

2. Related Art

Antireflective films as optical films have been used in various image display devices such as liquid crystal displays (LCD), plasma display panels (PDP), electroluminescence displays (ELD), or cathode ray tubes (CRT). The antireflective films have been also used in lenses of glasses or cameras.

Manufacturing methods of the optical films such as the antireflective films include chemical vapor deposition (CVD), physical vapor deposition (PVD), and vacuum deposition and spattering that are a kind of the physical vapor deposition, which are nonproductive and unsuitable for mass production.

On the other hand, methods for manufacturing an optical film such as an antireflective film by coating inorganic fine particles are productive and suitable for mass production. Such coating methods include dip coating, micro gravure coating, reverse roll coating, or the like. However, the dip coating tends to cause step-like unevenness, and the reverse roll coating and the micro gravure coating tend to cause step-like unevenness resulting from eccentricity or deformation of a roll. Also, these coating methods are of post measurement type, and it is relatively difficult to ensure a stable film thickness.

On the contrary, die coating is of a pre-measurement coating type, and advantageously provides a highly stable film thickness. Various proposals have been made for defining the shape of a pocket or defining the shape of a lip (Japanese Patent Application Laid-Open No. 11-128805, Japanese Patent Application Laid-Open No. 2003-236451, or the like).

Japanese Patent Application Laid-Open No. 11-128805 is a proposal for supplying a coating liquid from two or more coating liquid supply ports to a manifold to provide uniform coating film thickness distribution in a coating width direction. Japanese Patent Application Laid-Open No. 2003-236451 is a proposal for setting coating liquid pressure in a pocket to be higher than atmospheric pressure to prevent generation of bubbles and thus generation of coating stripes. Japanese Patent Application Laid-Open No. 2003-10762 is a proposal for setting a slot length or a slot width so as to obtain a coating state suitable for a liquid property and a coating condition of a coating liquid.

### SUMMARY OF THE INVENTION

However, if coating of a thin layer (for example, having a wet film thickness of 100 μm or less) is performed by the die coating disclosed in Japanese Patent Application Laid-Open No. 11-128805 and Japanese Patent Application Laid-Open No. 2003-236451, the film thickness in the width direction becomes nonuniform, or changes in the coating liquid pressure cause stripe-like unevenness, and it is difficult to maintain stable coating. In particular, for thin layer coating in which the coating liquid has low viscosity and the amount of coating liquid supplied is small, discharge of the liquid from a slot becomes unstable, and this tendency is remarkable.

The die coating disclosed in Japanese Patent Application Laid-Open No. 2003-10762 is a proposal directed to a coating liquid having high viscosity, and is different from a technique applicable to the case where the coating liquid has low viscosity and the amount of coating liquid supplied is small.

The present invention is achieved in view of such circumstances, and has an object to provide a coating method that can provide a uniform film thickness in a width direction, prevent stripe-like unevenness caused by changes in coating liquid pressure, and maintain stable coating even when coating of a thin layer (for example, having a wet film thickness of 100 μm or less) is performed, and an optical film, in particular, an antireflective film manufactured using the coating method.

In order to achieve the above described object, the present invention provides a coating method including the steps of: providing a pressure reducing chamber and a slot die adjacent to each other from an upstream side in a moving direction of a base material; providing a backup roller so as to face the slot die; and coating a coating liquid on the base material using the slot die, the base material being subjected to tension by the pressure reducing chamber, wound around the backup roller and continuously moved, wherein when
A=η×V×h×L×1/D³,
the coating liquid is coated under
2N/m²≦A≦700 N/m²,
where η is coating liquid viscosity, V is a coating speed, h is a coating film thickness in a wet state, L is a slot length, and D is a slot width.

According to the present invention, the coating is performed, with the slot length L, the slot width D, or the like defined, so as to reduce influences of pressure loss difference in a width direction of the base material in the slot die or dynamic pressure of the coating liquid, thereby providing a uniform film thickness in the width direction, preventing stripe-like unevenness caused by changes in coating liquid pressure, and allowing a stable coating state to be maintained.

Specifically, in manufacture of optical films or the like, discharge accuracy before a coating liquid is coated on a base material (web) is extremely significant. Coating on the optical film is extremely thin in terms of a quality requiring accuracy. Thus, coating is generally performed with a lip clearance of 100 μm or less.

At this time, it is found that increasing pressure loss in a slot with pressure reduction of a lip portion is extremely effective. Thus, if the degree of suction pressure reduction caused by the pressure reducing chamber is 0.1 to 1.5 kPa, optimizing the slot length L or the slot width D as defined by the above described formula provides a surface property with good coating thickness distribution in the web width direction.

In such a coating method, the suction pressure reduction caused by the pressure reducing chamber causes unstable discharge from the slot on a low viscosity side. Specifically, the coating liquid is drawn from the inside of the pocket by the pressure reduction at the low viscosity. Thus, when the value A is less than 2 N/m², the pressure loss is small, and the coating liquid is drawn from the inside of the pocket to cause poor discharge.

On the other hand, when the value A is more than 700 N/m², the pressure loss is large, and a portion through which the coating liquid easily passes and a portion through which the coating liquid does not easily pass are created while the coating liquid is discharged from the slot, which tends to cause stable discharge. This tendency is particularly remarkable in a pressure reducing system.

From the above, it is important to coat the coating liquid under the condition of 2 N/m²≦A≦700 N/m².

Essentially, the coating liquid viscosity η, the coating speed V, and the coating film thickness h in the wet state (the wet film thickness) are given values, and thus optimization of the slot length L and the slot width D in the above described formula can be generally adopted.

In the present invention, a flow speed of the coating liquid in the width direction of the base material in a pocket of the slot die is preferably set to 30 mm/sec or less. Such setting reduces influences of pressure loss difference in the width direction of the base material in the slot die or dynamic pressure of the coating liquid, thereby further achieving the advantage of the present invention.

The present invention also provides an optical film and an antireflective film including at least one coating layer obtained by the above described coating method.

As described above, according to the present invention, a uniform film thickness in a width direction can be provided, stripe-like unevenness caused by changes in coating liquid pressure can be prevented, and a stable coating state can be maintained.

### BRIEF DESCRIPTION OF THE DRAWINGS

FIG. 1 is a perspective view of a slot die and its surroundings of a coating device used in a coating method according to the present invention;

FIG. 2 is a partial sectional view of the coating device showing the surroundings of the slot die;

FIG. 3 is a perspective view showing a relationship between the slot die and a web;

FIG. 4 is a table showing conditions and results of Example 1; and

FIG. 5 is a table showing conditions and results of Example 2.

### DETAILED DESCRIPTION OF THE PREFERRED EMBODIMENTS

Now, a preferred embodiment of a coating method, an optical film and an antireflective film according to the present invention will be described in detail with reference to the accompanying drawings.

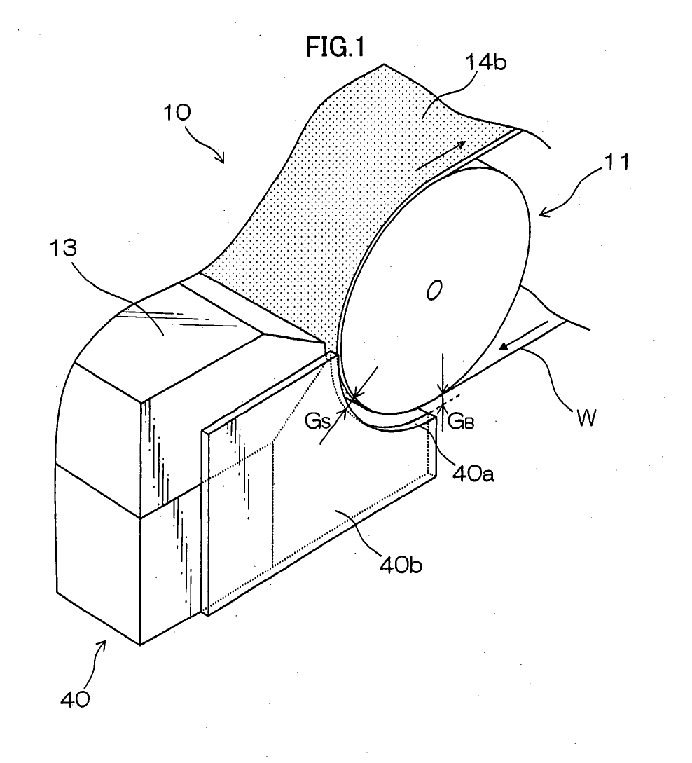

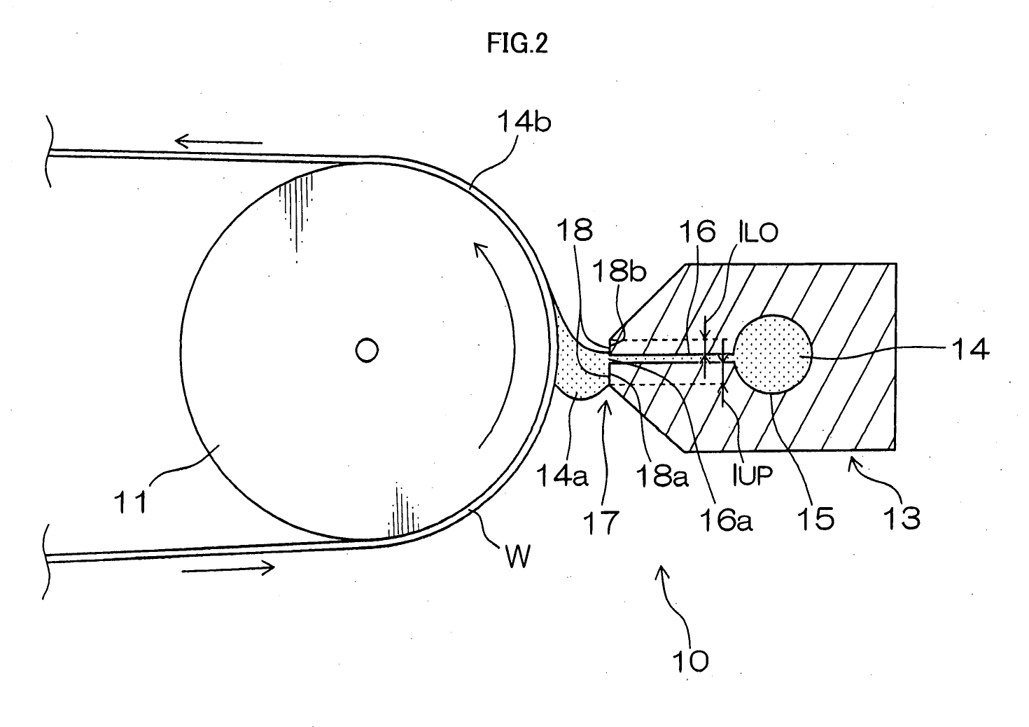

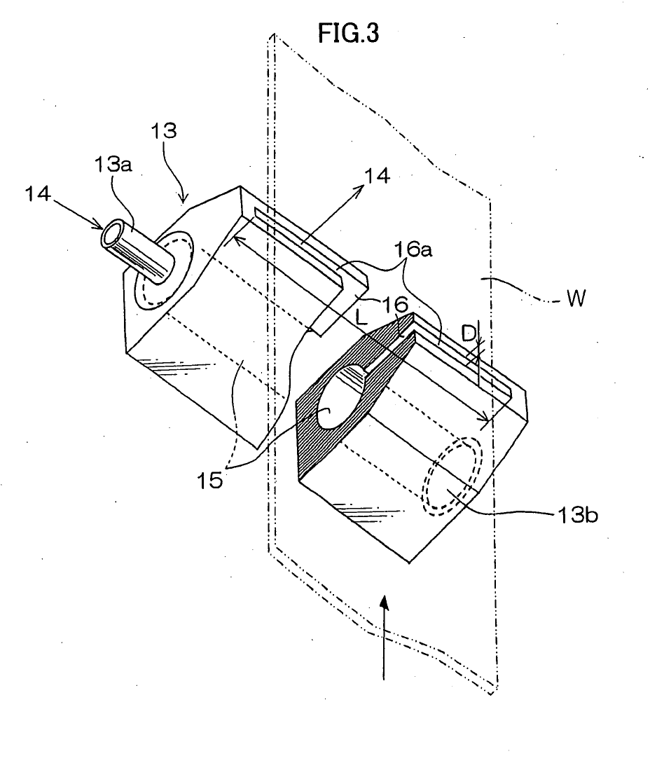

FIG. 1 is a perspective view of a slot die 13 and its surroundings of a coater (coating device) 10 used in a coating method according to the invention. FIG. 2 is a partial sectional view of the coater 10 showing the surroundings of the slot die 13. FIG. 3 is a perspective view showing a relationship between the slot die 13 and a web W with portions of the slot die 13 broken away so that the inside thereof is visible. In FIGS. 2 and 3, a pressure reducing chamber 40 is not shown.

The coater 10 is a coating device that coats a coating liquid 14 in beads 14a from the slot die 13 on the web W that is supported by a backup roller 11 and continuously moved to form a coating film 14b on the web W.

A pocket 15 and a slot 16 are formed in the slot die 13. The pocket 15 has a section formed by a curve and a straight line, and for example, the section may be substantially circular as shown in FIG. 2 or semicircular. The pocket 15 is a reservoir space for the coating liquid that is extended with the sectional shape in a width direction of the slot die 13, and the length of the effective extension is generally equal to or slightly longer than a coating width.

The coating liquid 14 is supplied to the pocket 15 from a supply pipe 13a on a side surface of the slot die 13 as shown in FIG. 3 or the center in a surface opposite to a slot opening 16a. At an end of the pocket 15 on the side opposite to the supply pipe 13a, a plug 13b is provided for preventing leak of the coating liquid 14.

The slot 16 is a channel along which the coating liquid 14 passes from the pocket 15 to the web W, and has a sectional shape in the width direction of the slot die 13 like the pocket 15. The opening 16a having a width D positioned on the web side is adjusted to have a length L substantially equal to the coating width using an unshown width control plate or the like. An angle between a tip of the slot 16 and a tangent of the backup roller 11 in a web moving direction is preferably 30° to 90°.

A tip lip 17 of the slot die 13 in which the opening 16a of the slot 16 is positioned is tapered, and the tip thereof is a flat portion 18 referred to as a land. An upstream side of the land 18 in the moving direction of the web W with respect to the slot 16 is referred to as an upstream lip land 18a, and a downstream side thereof is referred to as a downstream lip land 18b. The distances from the upstream lip land 18a and the downstream lip land 18b to the web W are equal.

A land length IUP of the upstream lip land 18a is not limited, but a range of 500 μm to 1 mm is preferable. A land length ILO of the downstream lip land 18b is 300 μm to 100 mm, and preferably 30 μm to 80 μm.

When the land length ILO of the downstream lip is shorter than 30 μm, an edge or the land of the tip lip 17 is apt to be chipped to cause stripes on a coating film and consequently make coating impossible. Further, setting of a wet line position on the downstream side becomes difficult, and the coating liquid is apt to spread on the downstream side. It has been known that a leak spread of the coating liquid on the downstream side means a nonuniform wet line, causing poor shapes such as stripes on a coating surface.

On the other hand, when the land length ILO of the downstream lip is longer than 100 μm, the pressure reduction needs to be increased, which provides unstable beads, and thus thin layer coating is extremely difficult.

The upstream lip land 18a and the downstream lip land 18b that are the tip portion of the slot die 13 are made of carbide material. If a material such as stainless steel or the like is used in the tip portion of the slot die 13, the material wears in the step of die machining, and satisfactory machining accuracy of the tip lip often cannot be obtained. Thus, in order to maintain high machining accuracy, a tip portion made of carbide material as disclosed in Japanese Patent No. 2817053 are preferably used.

Specifically, at least the tip lip of the slot die 13 is preferably made of cemented carbide obtained by coupling carbide crystals having an average particle size of 5 μm or less. The cemented carbide includes crystal particles of carbide such as tungsten carbide (hereinafter abbreviated as WC) coupled by binding metal such as Co (cobalt). As the binding metal, Ti (titan), Ta (tantalum), Nb (niobium), and a combination thereof may be used. The average particle size of the WC crystal is more preferably 3 μm or less.

At the tip of the slot die 13, radii of curvature of the tip edges of the upstream lip land 18a and the downstream lip land 18b are preferably 10 μm or less. Surface roughness Ra of the tip portion of the slot die 13 (the upstream lip land 18a and the downstream lip land 18b) is preferably 0.4 μm or less. Such a tip portion of the slot die 13 facilitates maintaining a constant bead shape.

In FIG. 1, the pressure reducing chamber 40 is provided on the slot die 13 on the side opposite to the moving direction of the web W and in a position with no contact with the web W so as to allow sufficient pressure reducing adjustment for the bead 14a. The pressure reducing chamber 40 includes a back plate 40a and a side plate 40b for maintaining operation efficiency thereof, and gaps GB and GS are provided between the back plate 40a and the web W and between the side plate 40b and the web W, respectively.

In the coating method according to the present invention, a coating liquid using various known solvents may be used. For example, water, various halogenated hydrocarbons, alcohol, ether, ester, ketone, or the like are used solely or in combination.

As the web W, various known webs may be used. Generally, the webs include various known plastic films such as polyethylene terephthalate, triacetyl cellulose, polyethylene-2,6-naphtalate, cellulose diacetate, cellulose triacetate, cellulose acetate propionate, polyvinyl chloride, polyvinylidene chloride, polycarbonate, polyimide or polyamide, paper, various types of laminated paper obtained by coating or laminating α-polyolefins with a carbon number of 2 to 10 such as polyethylene, polypropylene or ethylene butane copolymer on paper, metal foils such as aluminum, copper or tin, or a strip-like base material having a reserve machining layer formed on a surface thereof.

As the coating liquid used in the coating method according to the present invention, an optical compensation sheet coating liquid, an antireflective film coating liquid, an anti-glare liquid magnetic coating liquid, a photosensitive coating liquid, a magnetic coating liquid, a viewing angle enlarging coating liquid, a surface protection liquid, an antistatic liquid, a lubricating coating liquid, a color filter pigment liquid, or the like may be used, though not exclusively.

The coating method of the present invention is effective in a system for coating a thin layer having a wet thickness of 100 μm or less, and preferably used in a system for accurate coating with a thickness of 20 μm or less. Besides single layer coating, the method is also effective in successive multiple layer coating, in particular, in thin film coating with high accuracy such that each layer has a wet thickness of 20 μm or less. Remarkable advantages may be obtained when the coating liquid has viscosity of 0.5 to 100 mPa·s, in particular, 20 mPa·s or more. Surface tension is preferably 20 to 70 mN/m, and more preferably 20 to 35 N/m.

In the coating method of the present invention, applicable coating speeds are up to approximately 100 m/min. The coating method is more effective in an area where coating is generally difficult, a coating system with a thinner wet film thickness, and an area with high viscosity.

Next, the coating method using the above described coating device will be described.

The web W is wound around the backup roller 11, the pressure reducing chamber 40 is maintained at a pressure reducing state to provide tension to the web W, and the backup roller 11 is rotated to continuously move the web W. Then, the slot die 13 is used to coat the coating liquid 14 on the surface of the web W to form the coating film 14b on the web W.

At this time, a value A calculated by Formula 1 described below is set to be 2 N/m² or more and 700 N/m² or less.
A=η×V×h×L×1/D³ (Formula 1)
where η is coating liquid viscosity (in N·s/m²), V is a coating speed (in m/s), h is a coating film thickness in a wet state (in m), L is a slot length (in m), and D is a slot width (in m).

The value A is preferably set to be 2 N/m² or more and 500 N/m² or less, and more preferably set to be 2 N/m² or more and 300 N/m² or less.

In order to obtain a uniform coating film 14b, more preferably, the coating liquid viscosity η is 0.01 N·s/m² or less, the amount of coating is 15 ml/m² or less, and the flow speed of the coating liquid 14 in the width direction of the web W in the pocket 15 is 14 mm/s or less.

This provides a uniform thickness in the web width direction, prevents stripe-like unevenness caused by changes in coating liquid pressure, and allows a stable coating state to be maintained.

The embodiment of the coating method according to the present invention has been described, but the present invention is not limited to the embodiment and various aspects may be adopted.

For example, in the embodiment, the distances from the upstream lip land 18a and the downstream lip land 18b of the slot die 13 to the web W are equal, but a slot die of so-called overbite type in which distances from the upstream lip land 18a and the downstream lip land 18b to the web W are different may be used. This also achieves the same advantage as the present invention.

### EXAMPLES

### Example 1

A coating liquid for an anti-glare film that is an optical film was prepared as described below.

First, 75 g of a mixture of dipentaerythritol pentaacrylate and dipentaerythritol hexaacrylate (DPHA, manufactured by Nippon Kayaku Co., Ltd.) and 240 g of hard coat coating liquid containing dispersed zirconium oxide ultrafine particles having a particle size of about 30 nm (DeSolite Z-7401, manufactured by JSR Corporation) were dissolved in 104 g of a mixed solvent of methylethylketon and cyclohexanone (54% and 46% by weight).

To the obtained solution, 10 g of a photo polymerization inhibitor (Irgacure 907, manufactured by Ciba Specialty Chemicals K. K.) was added, and after stirring and dissolving, 0.93 g of a fluorochemical surfactant consisting of a methylethylketon solution containing 20% by weight of fluorochemical oligomer (Megafac F-176 PF, manufactured by Dainippon Ink and Chemicals, Incorporated) was added. (A refractive index of a coating film obtained by coating this solution and then curing the solution with ultraviolet light was 1.65).

Further, to this solution, 20 g of crosslinked polystyrene particles (SX-200HS, manufactured by Soken Chemical & Engineering Co., Ltd.) having an average particle size of 2.0 μm and a refractive index of 1.61 was added, and stirred and dispersed in 160 g of a mixed solvent of methylethylketon and cyclohexanone (54% and 46% by weight) using DESPA (a high speed mixer manufactured by Asada Iron Works Co., Ltd.) at 5000 rpm for an hour. Then, 29 g of a dispersion liquid obtained by filtering through polypropylene filters having hole sizes of 10 μm, 3 μm, and 1 μm (PPE-10, PPE-03, and PPE-01, respectively, manufactured by Fuji Photo Film Co., Ltd.) was added and stirred, and then filtered by a polypropylene filter having a hole size of 30 μm to prepare an anti-glare mother coating liquid.

Further, to this solution, 960 g of methylethylketon (hereinafter abbreviated as “MEK”) was added to prepare a liquid having a concentration described below.

For this coating liquid, viscosity was 0.004 N·s/m², surface roughness was 0.029 N/m, and a mass ratio between a solid and the solvent was 17/83. This is a preparation liquid A.

For the original anti-glare mother coating liquid, viscosity was 0.007 N·s/m², surface roughness was 0.033 N/m, and a mass ratio between a solid and the solvent was 50/50. This is a preparation liquid B.

As a web W, a triacetyl cellulose film (hereinafter abbreviated as “TAC”) having a thickness of 80 μm and a width of 1300 mm was used.

While moving the web W, the preparation liquid A was coated on the web by the die coater according to the present invention, with the amount of the preparation liquid A per 1 m² area being 15 m/m².

At this time, the degree of pressure reduction was 0.3 kPas. The die coater having a tip portion made of stainless steel was used. An enclosure was provided 10 cm above the coating film immediately after coating and side portions were also enclosed for drying so as to prevent the coating surface from being directly exposed to wind during the drying.

Under the same conditions, while moving the web W made of TAC, the preparation liquid B was coated on the web by the die coater according to the present invention, with the amount of the preparation liquid B per 1 m² area being 5 ml/m².

A coating liquid for an antireflective film that is an optical film was prepared as described below.

To 93 g of a methylethylketon solution (JN-7228, manufactured by JSR Corporation) having a refractive index of 1.42 and containing 6% by weight of thermally crosslinked fluorochemical polymer, 8 g of MEK-ST (having an average particle size of 10 nm to 20 nm, dispersed methylethylketon of SiO₂ sol having a solid concentration of 30% by weight, manufactured by Nissan Chemical Industries, Co., Ltd.), 94 g of methylethylketon, and 6 g of cyclohexanone were added and stirred. Then, the solution was filtered by the polypropylene filter (PPE-01) having the hole size of 1 μm to prepare a coating liquid for a low refractive index layer. For this coating liquid, viscosity was 0.001 N·s/m², and surface roughness was 0.024 N/m. This is a preparation liquid C.

The liquid was coated on the web having the above described anti-glare layer formed thereon in a long range, and the web was wound around a roller of a feeder, and then unwound and moved. The liquid was coated by the die coater at a moving speed of the web of 10 m/min so that the film thickness is 4 μm (the amount of coating is 4 ml/m²) during the coating.

The preparation liquids A, B and C were coated with a coating speed V changed to 10 to 30 m/min, a coating thickness h (the amount of coating) in a wet state changed to 4 to 15 ml/m², a slot length L changed to 30 to 100 mm, and a slot width D changed to 60 to 500 μm.

The value A in Formula 1 described above was calculated in each coating condition.

For evaluation of the coating results, a generation state of stripes and distribution in the web width direction were visually evaluated. This visual evaluation is a sensory test of the web W after coating performed with a fluorescent lamp behind the web.

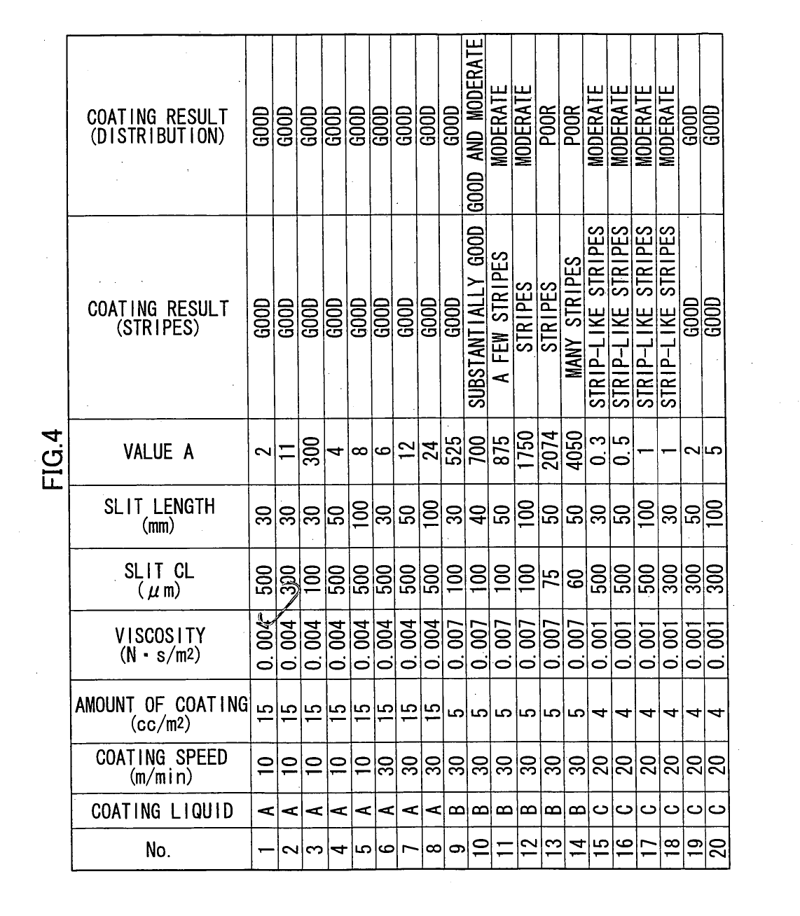

The above described conditions and results are summarized in the table in FIG. 4.

In the table in FIG. 4, for Examples 15 to 18 where the value A is 1 or less, poor surface properties such as stripes were created, the distribution in the web width direction was moderate, and thus both were poor.

For Examples 11 to 14 where the value A is large (875 to 4050), poor surface properties such as stripes were created by poor discharge, the distribution in the web width direction was moderate or poor, and thus both were poor.

On the other hand, for the examples where the value A is 2 to 700, no stripe was created, the distribution in the web width direction was good, and thus general evaluation was good.

### Example 2

The same web W as in Example 1 (TAC) was used, and the preparation liquid A in Example 1 was used as a coating liquid.

Three kinds of slot dies 13 having pockets 15 of different sizes were prepared so that flow speeds in the pockets can be changed.

The coating liquid was coated with a coating thickness h (the amount of coating) in a wet state fixed at 15 ml/m², a slot width D fixed at 500 μm, a coating speed V fixed at 10 m/min, and a slot length L fixed at 50 mm. The flow speeds in the pockets at this time were 1.4 to 5.5 cm/s.

The value A in Formula 1 described above was adjusted to 4 in each coating condition.

For evaluation of the coating results, distribution in the web width direction was visually evaluated. This visual evaluation was the same sensory test as in Example 1.

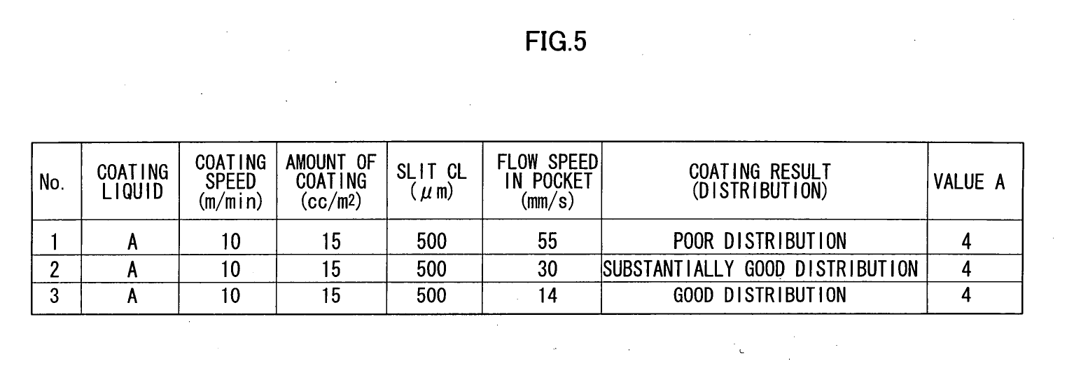

The above described conditions and results are summarized in the table in FIG. 5.

In the table in FIG. 5, for Example 1 where the flow speed in the pocket is 55 mm/s higher than 30 mm/s, the distribution in the web width direction was poor. This may be because the flow speed in the pocket is high, and dynamic pressure causes poor discharge to cause poor distribution.

On the other hand, for Examples 2 and 3 where the flow speed in the pocket is 30 mm/s or less, the distribution in the web width direction was good. This may be because the flow speed in the pocket is low, and dynamic pressure has little influence.

What is claimed is:

1. A coating method comprising the steps of:
providing a pressure reducing chamber and a slot die adjacent to each other from an upstream side in a moving direction of a base material;
providing a backup roller so as to face said slot die; and
coating a coating liquid on said base material using said slot die, said base material being subjected to tension by said pressure reducing chamber, wound around said backup roller and continuously moved,
wherein when
A=η×V×h×L×1/D³,
the coating liquid is coated under
2N/m²≦A≦700 N/m²,
where η is coating liquid viscosity, V is a coating speed, h is a coating film thickness in a wet state, L is a slot length, and D is a slot width.

2. The coating method according to claim 1, wherein a flow speed of said coating liquid in a width direction of said base material in a pocket of said slot die is set to 30 mm/sec or less.

3. An optical film comprising at least one coating layer obtained by a coating method according to claim 1.

4. An optical film comprising at least one coating layer obtained by a coating method according to claim 2.

5. An antireflective film comprising at least one coating layer obtained by a coating method according to claim 1.

6. An antireflective film comprising at least one coating layer obtained by a coating method according to claim 2.
